(19) United States
(12) Patent Application Publication
(10) Pub. No.: US 2025/0342190 A1
(43) Pub. Date: Nov. 6, 2025

(54) Wearable AI Assistant with Predictive Buffering, Multi-Modal Contextual Input, and Privacy-Guarded Ambient Learning

(71) Applicant: LARRY LIM KHENG CHEONG, SINGAPORE (SG)

(72) Inventor: LARRY LIM KHENG CHEONG, SINGAPORE (SG)

(21) Appl. No.: 19/215,376

(22) Filed: May 22, 2025

(51) Int. Cl. G06F 16/334; G06F 3/01; H04R 9/06

(52) U.S. Cl. CPC G06F 16/334; G06F 3/017; H04R 9/06; H04R 2460/13

(57) ABSTRACT

The invention introduces a Total Wave structure of the Modified Schrödinger Equation (MSE) that deterministically governs quantum collapse using co-evolving field-specific wave-functions. Unlike conventional quantum mechanics, which treats wavefunction collapse as a postulated or probabilistic phenomenon, this invention models collapse as a structured outcome of wave interference from multiple physical fields—electromagnetic, gravitational, strong nuclear, and weak nuclear—each governed by its own nonlinear MSE.
The system wavefunction Ψₚ evolves under the influence of these field-specific observer waves Ψⱼ, and collapse occurs when the total interference term exceeds a defined threshold. This model supports not only collapse but also resonance (sub-threshold wave alignment) and non-collapse (persistent superposition), forming a tri-state mechanism of existence.
The Total Wave MSE formalism applies to quantum hardware design, computation, sensing, and AI-guided control. By treating collapse as an engineered interference event, the invention enables deterministic reality selection across multiple domains. It extends the scope of earlier MSE patents and proposes that this structure represents a scalable, tunable, and physically grounded Theory of Everything (TOE).

### FIELD OF THE INVENTION

The present invention relates to physical modeling systems, quantum measurement theory, and computational frameworks for reality selection. Specifically, it introduces a field-based structure of Modified Schrödinger Equations (MSE) to describe, control, and predict quantum collapse as a deterministic outcome of structured wave interference (claim 1).

### BACKGROUND AND MOTIVATION

Traditional quantum theory offers no deterministic model for wavefunction collapse. The standard Schrödinger equation is linear and unitary, preserving superpositions indefinitely unless a “measurement” is invoked by postulate. This obscures the physical mechanism of collapse and creates paradoxes such as the measurement problem and Many-Worlds interpretations.

Earlier patents introduced a nonlinear MSE model incorporating an observer wavefunction Ψₒ to simulate collapse (claim 2). However, those formulations assumed a single dominant field, usually electromagnetic (EM), to trigger interference.

### SUMMARY OF THE INVENTION

This invention expands the model to include a Total Wave MSE framework, in which observer influence is distributed across a set of co-evolving field wavefunctions—EM, gravitational, strong nuclear, and weak nuclear (claims 1, 3, 4). Each wavefunction Ψⱼ evolves under its own MSE, and together they define the condition for collapse, resonance, or superposition maintenance.

The system wavefunction Ψₚ evolves as:

$$i ℏ \partial {Ψ}_{p} / \partial t = [ - ( {h}^{2} / 2 m ) {∇}^{2} + {V}_{p} ( r ) + {\sum }_{j} ( {γ}_{j} {\vert {Ψ}_{j} \vert}^{2} - {δ}_{j} {Ψ}_{j} ) ] {Ψ}_{p}$$

Each Ψⱼ satisfies:

$$i ℏ \partial {Ψ}_{j} / \partial t = [ - ( {ℏ}^{2} / 2 {m}_{j} ) {∇}^{2} + {V}_{j} ( r ) + {γ}_{j} {\vert {Ψ}_{j} \vert}^{2} - {δ}_{j} {Ψ}_{j} ] {Ψ}_{j} \qquad ( Claim 4 )$$

Collapse, Resonance, and Non-Collapse States: This system models three distinct reality-selection states (claim 5):
Collapse: When net interference exceeds threshold, a singular outcome is selected.
Resonance: Fields align coherently but do not cause collapse; system remains stable.
Non-Collapse: No sufficient interaction; superposition persists.

The interference term is defined as:

$$𝒞 ( r , t ) = {\sum }_{j} ( {γ}_{j} {\vert {Ψ}_{j} ( r , t ) \vert}^{2} - {δ}_{j} Re [ {Ψ}_{j} ( r , t ) ] )$$

Collapse occurs when:

$$𝒞 ( r , t ) \geq θ\_collapse$$

Homogeneous vs. Non-Homogeneous Field Dynamics: This invention distinguishes between:
Homogeneous interactions: Collapse triggered by field-wave interference of the same type (e.g., EM-EM, Gravity-Gravity). These are dominant in experiments (claim 6).
Non-Homogeneous interactions: Cross-field interactions (e.g., EM-Gravity) that are usually negligible under laboratory conditions, but retained in the framework for tuning potential (claim 7).

Resonant Field Tuning and Modulation: Collapse zones can be dynamically engineered by tuning the γⱼ and δⱼ coefficients across Ψⱼ fields. This enables:
Collapse reinforcement or suppression (claim 8)
Targeted selection via spatial amplitude control and phase alignment
Creation of dynamic thresholds to support computation, sensing, or decision-making tasks

Experimental Relevance: The model explains why EM fields typically dominate collapse in optical setups, while other fields act residually. It also provides a framework to design experimental setups where gravitational or nuclear waves might be amplified to test their influence on system collapse (claim 9).

Position as a Theory of Everything (TOE): The Total Wave MSE provides a deterministic and testable operating system for physical reality. It:
Unifies all fundamental fields through structured interference, not geometric unification
Replaces the randomness of traditional collapse with threshold-driven field interaction
Encodes the conditions for when, how, and why wavefunctions become real (claim 10)

This unification is not algebraic but operational—at the moment when interference crosses threshold and collapse selects an outcome.

Conclusion: This specification supports the claims of a deterministic, field-driven MSE model for reality selection. It defines collapse as an emergent consequence of wave interaction among co-evolving fields. By modeling observer influence through a Total Wave system of nonlinear MSEs, this invention provides both a theoretical and practical structure for controlling measurement, emergence, and quantum computation.

The Total Wave MSE is more than a measurement theory—it is a candidate Theory of Everything, grounded not in speculation, but in calibrated wave interference and deterministic physical evolution.

1. A system for modeling quantum collapse as a deterministic interference effect, comprising:
a plurality of observer wavefunctions Ψⱼ representing fundamental physical fields including electromagnetic, gravitational, strong nuclear, and weak nuclear forces;
a system wavefunction Ψₚ representing the quantum particle or state being measured;
a coupled set of Modified Schrödinger Equations (MSEs) governing the evolution of each Ψⱼ:
$$i ℏ \frac{\partial {Ψ}_{j}}{\partial t} = [ - \frac{{ℏ}^{2}}{2 {m}_{j}} {∇}^{2} + {V}_{j} ( r ) + {γ}_{j} {\vert {Ψ}_{j} \vert}^{2} - {δ}_{j} {Ψ}_{j} ] {Ψ}_{j} ,$$
and an interaction equation for Ψₚ of the form:
$$i ℏ \frac{\partial {Ψ}_{p}}{\partial t} = [ - \frac{{ℏ}^{2}}{2 m} {∇}^{2} + {V}_{p} ( r ) + {\sum }_{j} ( {γ}_{j} {\vert {Ψ}_{j} \vert}^{2} - {δ}_{j} {Ψ}_{j} ) ] {Ψ}_{p} ,$$
wherein quantum collapse is determined when the total interference term
$$𝒞 ( r , t ) = {\sum }_{j} ( {γ}_{j} {\vert {Ψ}_{j} ( r , t ) \vert}^{2} - {δ}_{j} Re [ {Ψ}_{j} ( r , t ) ] )$$
exceeds a threshold value θ_{collapse}.

2. The system of claim 1, wherein said observer wavefunctions Ψⱼ operate either independently or in synchrony to cause:
(a) a Collapse state when [symbol] (r,t)≥θ_{collapse};
(b) a Resonance state when fields are aligned but below collapse threshold;
(c) a Non-Collapse state when net interference is insufficient to induce reality selection.

3. The system of claim 1, wherein at least one Ψⱼ is an electromagnetic (EM) wave and serves as the dominant contributor to collapse in laboratory-scale quantum systems.

4. The system of claim 1, wherein gravitational, strong, or weak nuclear fields are represented by additional Ψⱼ terms that contribute residual but non-negligible influence under engineered or extreme conditions.

5. The system of claim 1, further comprising control of collapse behavior via tuning of γⱼ and δⱼ parameters to:
modulate collapse spatially or temporally,
suppress or delay collapse onset,
enhance constructive interference for measurement or sensing.

6. The system of claim 1, wherein collapse modeling is used to design or calibrate quantum hardware, enabling configuration of field geometries to minimize premature collapse or maximize computational fidelity.

7. The system of claim 1, wherein said model is used to classify collapse conditions into homogeneous interactions (within same field type) and non-homogeneous interactions (across field types), with only dominant-field contributions required for practical measurement modeling.

8. The system of claim 1, wherein the interference framework is further extended to support applications in:
quantum memory and read/write localization,
AI-directed collapse modulation,
quantum sensing,
biological or biofield signal recognition,
and theoretical cosmology or time-asymmetric evolution.

9. A method of operating a quantum system using the model of claim 1, comprising:
initializing Ψⱼ field profiles with calibrated γⱼ and δⱼ values,
evolving each Ψⱼ and Ψₚ via their MSEs,
continuously monitoring the total interference term [symbol] (r, t), and inducing collapse precisely when [symbol] (r, t) exceeds θ_{collapse}.

10. The method of claim 9, wherein said collapse is interpreted as the physical realization of measurement, existence, or computational outcome, thereby forming a deterministic and engineerable reality selection system.
